(19) United States
(12) Patent Application Publication
(10) Pub. No.: US 2023/0359693 A1
(43) Pub. Date: Nov. 9, 2023

(54) CORRELATION COMPUTATION METHOD FOR SHARING COMMON DATA AND COMPUTATION FOR DIFFERENT CODE SEQUENCES TO BE CORRELATED WITH DATA SEQUENCE AND ASSOCIATED APPARATUS

(71) Applicant: MEDIATEK INC., Hsin-Chu (TW)

(72) Inventor: Kun-Tso Chen, Hsinchu City (TW)

(73) Assignee: MEDIATEK INC., Hsin-Chu (TW)

(21) Appl. No.: 18/139,954

(22) Filed: Apr. 27, 2023

Related U.S. Application Data
(60) Provisional application No. 63/338,913, filed on May 6, 2022.

(51) Int. Cl. G06F 17/15

(52) U.S. Cl. CPC G06F 17/15

(57) ABSTRACT

A correlation computation method includes: obtaining a first sum of all data samples included in a data sequence; obtaining a second sum of selected data samples that are selected from the data sequence according to code bits included in a first code sequence; and deriving, by a processing circuit, a first correlation value between the data sequence and the first code sequence from the first sum and the second sum.

### CROSS REFERENCE TO RELATED APPLICATIONS

This application claims the benefit of U.S. Provisional Application No. 63/338,913, filed on May 6, 2022. The content of the application is incorporated herein by reference.

### BACKGROUND

The present invention relates to correlation computation, and more particularly, to a correlation computation method for sharing common data and computation for different code sequences to be correlated with a data sequence and an associated apparatus.

The global navigation satellite system (GNSS) is often described as an “invisible utility”, and is so effective at delivering two essential services—time and position—accurately, reliably and cheaply that many aspects of the modern world have become dependent upon them. Each satellite of the GNSS is equipped with a highly precise atomic clock. When four or more satellites are in view, a GNSS receiver can measure the distance to each satellite by estimating the signal transmission time delay from the satellite to the receiver. From these measurements, a GNSS-embedded device can derive its own position and synchronize to the accurate GNSS system time.

A GNSS satellite signal is modulated by pseudo random noise (PRN) code. The PRN code is a code sequence with randomly distributed 0's and 1's. Each satellite transmits a unique PRN code. Hence, the GNSS receiver identifies any of the satellites by its unique PRN code. The unique PRN code is continuously repeated. The GNSS receiver uses a local replica version of the satellite signal to correlate the received satellite signal. The purpose of the correlation process is to synchronize the timing between the local replica and the received satellite signal. Because the timing is unknown and dynamic, the received satellite PRN code sequence must be correlated with a plurality of its time-shifted versions. If the satellite PRN code sequence is unknown, the receiver must try all the possible sequences. Lots of computations, including multiplication operations and summation operations, are required if the code sequence is long and/or there are many satellite code sequences to correlate. Thus, there is a need for an innovative correlation computation design with reduced computation complexity.

### SUMMARY

One of the objectives of the claimed invention is to provide a correlation computation method for sharing common data and computation for different code sequences to be correlated with a data sequence and an associated apparatus.

According to a first aspect of the present invention, an exemplary correlation computation method is disclosed. The exemplary correlation computation method includes: obtaining a first sum of all data samples included in a data sequence; obtaining a second sum of selected data samples that are selected from the data sequence according to code bits included in a first code sequence; and deriving, by a processing circuit, a first correlation value between the data sequence and the first code sequence from the first sum and the second sum.

According to a second aspect of the present invention, an exemplary correlation computation apparatus is disclosed. The exemplary correlation computation apparatus includes an accumulation-based circuit and a processing circuit. The accumulation-based circuit is arranged to obtain a first sum of all data samples included in a data sequence, and obtain a second sum of selected data samples that are selected from the data sequence according to code bits included in a first code sequence. The processing circuit is arranged to derive a first correlation value between the data sequence and the first code sequence from the first sum and the second sum.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a correlation computation apparatus according to an embodiment of the present invention.

FIG. 2 is a diagram illustrating a first design of the correlation computation apparatus shown in FIG. 1 according to an embodiment of the present invention.

FIG. 3 is a diagram illustrating a second design of the correlation computation apparatus shown in FIG. 1 according to an embodiment of the present invention.

FIG. 4 is a diagram illustrating a third design of the correlation computation apparatus shown in FIG. 1 according to an embodiment of the present invention.

FIG. 5 is a diagram illustrating a fourth design of the correlation computation apparatus shown in FIG. 1 according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

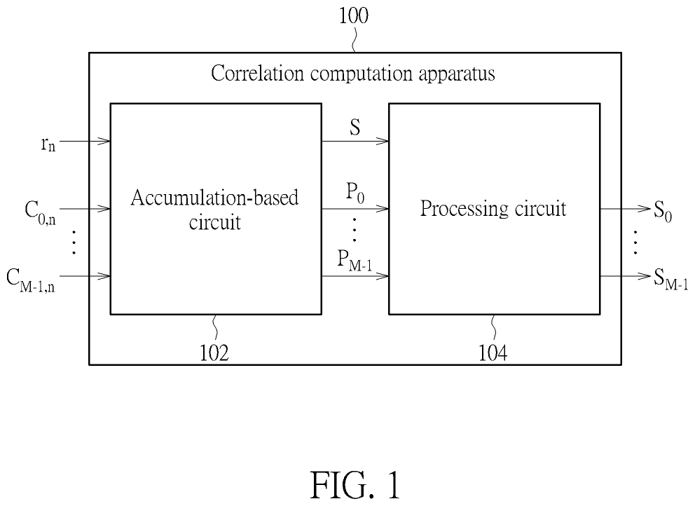

FIG. 1 is a block diagram illustrating a correlation computation apparatus according to an embodiment of the present invention. By way of example, but not limitation, the correlation computation apparatus 100 may be a part of a correlator in a GNSS receiver that may support processing of modern GNSS signals, including GPS L5, GPS L2C, GPS L1C, GPS L1C/A, BeiDou B2a, BeiDou B2b, BeiDou B1C, BeiDou B1I, Galileo E5a, Galileo E5b, Galileo E6, Galileo E1, GLONASS L1OF, NavIC L1, NavIC L5, SBAS L1, and so on. In practice, any application using the proposed correlation computation apparatus 100 to deal with computation of correlation values falls within the scope of the present invention. That is, this design can also be applied to other applications that compute correlation values between one block of N data samples and lots of different code sequence samples. In this embodiment, the correlation computation apparatus 100 includes an accumulation-based circuit 102 and a processing circuit 104. It should be noted that only the components pertinent to the present invention are illustrated in FIG. 1. In practice, the correlation computation apparatus 100 may include additional components for other designated functions. In one exemplary design, the correlation computation apparatus 100 may be implemented using dedicated hardware that is designed to perform the proposed correlation computation method. In another exemplary design, the correlation computation apparatus 100 may be implemented using a general-purpose processor that loads and executes program codes to perform the proposed correlation computation method. In yet another exemplary design, the correlation computation apparatus 100 may be implemented using any combination of hardware and software. To put it simply, any correlation computation design using the proposed computation complexity reduction technique falls within the scope of the present invention.

The accumulation-based circuit 102 is arranged to obtain a sum S of all data samples included in a data sequence rₙ. For example, the data sequence rₙ is a data block of N (N>1) received data samples {rₙ, n=0, . . . , N−1} output from an analog-to-digital converter (ADC). Hence, the sum S can be expressed by the following formula.

S=Σₙ₌₀^{N-1}rₙ (1)

The ADC can capture one sample of the received signal per PRN code bit. Or several samples per PRN code bit are captured by the ADC and are processed further to get a data sample per PRN code bit. On the other hand, the samples per PRN code bit can be used to correlate with the corresponding samples of a local PRN code bit. Other signal processing might be applied before correlation, such as carrier frequency or Doppler frequency removal. In order to describe our invention more clearly, the following embodiments use one sample per PRN code bit and without other signal processing.

In this embodiment, the correlation computation apparatus 100 is used to correlate the same data sequence rₙ with M (M>1) code sequences (i.e., PRN codes) C_{m,n} {C_{m,n}, m=0, . . . , M−1, n=0, . . . , N−1} for generating M correlation values S₀-S_{M-1}, respectively. In other words, each of the code sequences C_{0,n}-C_{M-1,n} has N code bits (also called chips due to bearing no useful data information). With regard to computation of a correlation value Sᵢ (i={0, . . . , M−1}) between the data sequence rₙ and a code sequence C_{i,n}, the accumulation-based circuit 102 is arranged to obtain a partial sum Pᵢ of selected data samples that are selected from the data sequence rₙ according to code bits included in the code sequence C_{i,n}; and the processing circuit 104 is arranged to derive the correlation value Sᵢ between the data sequence rₙ and the code sequence C_{i,n} from the sum S and the partial sum Pᵢ.

As one of the examples, the transmitted data of a satellite is modulated by bitwise XOR with a code sequence (i.e., a PRN code) according to code-division multiple access (CDMA) spectrum sharing scheme. The resulting spread-spectrum sequence is modulated by binary phase shift keying (BPSK) for transmission, where a logic value 0 of the spread-spectrum sequence is mapped to +1 for BPSK modulation, and a logic value 1 of the spread-spectrum sequence is mapped to −1 for BPSK modulation. At the receiver side, the correlation value Sᵢ between the data sequence rₙ {rₙ, n=0, . . . , N−1} and the code sequence C_{i,n} {C_{i,n}, n=0, . . . , N−1} may be computed using the following formula.

$${S}_{i} = {\sum }_{n = 0}^{N - 1} {D}_{i , n} \cdot {r}_{n} , where {D}_{i , n} = \{ \begin{matrix}1 , if {C}_{i , n} = 0 \\ - 1 , if {C}_{i , n} = 1\end{matrix} \qquad ( 2 )$$

The above formula (2) can be reformulated as below.

Sᵢ=Σₙ₌₀^{N-1}D_{i,n}·rₙ=Σₙ₌₀^{N-1}(1−2·C_{i,n})·rₙ=Σₙ₌₀^{N-1}rₙ−2·Σₙ₌₀^{N-1}C_{i,n}·rₙ=S−2·Pᵢ (3)

In the above formula (3), the partial sum Pᵢ can be expressed by the following formula.

$${P}_{i} = {\sum }_{n = 0}^{N - 1} {δ}_{{C}_{i , n}} \cdot {r}_{n} , where {δ}_{{C}_{i , n}} = \{ \begin{matrix}0 , if {C}_{i , n} = 0 \\ 1 , if {C}_{i , n} = 1\end{matrix} \qquad ( 4 )$$

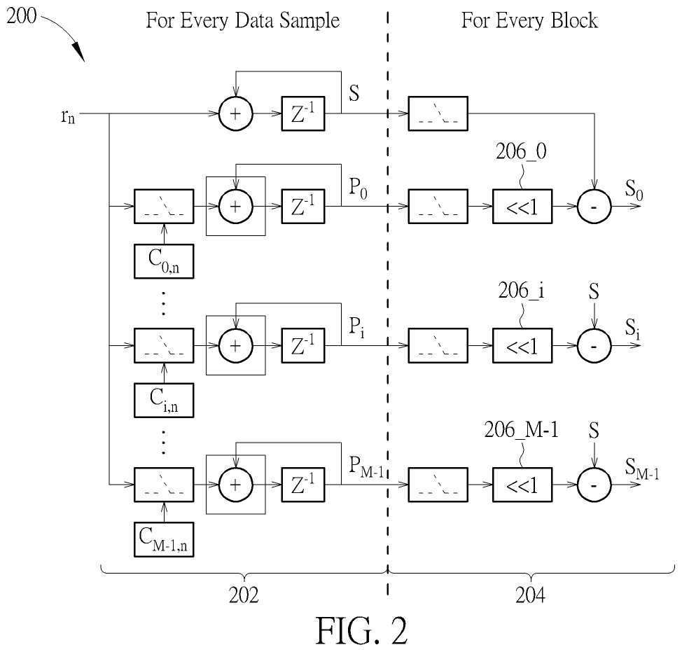

Based on above formulas (1), (3) and (4), the correlation computation apparatus 100 shown in FIG. 1 may be implemented using the correlation computation apparatus 200 shown in FIG. 2, where the accumulation-based circuit 102 may be implemented by the circuit block 202, and the processing circuit 104 may be implemented by the circuit block 204.

Since data samples in the data sequence rₙ that are paired with the corresponding zero code bits C_{i,n}=0 have no contribution to the partial sum Pᵢ, the accumulation-based circuit 102 is allowed to obtain the partial sum Pᵢ by accumulating data samples paired with the corresponding non-zero code bits C_{i,n}=1 only. Since the number of selected data samples selected from the data sequence rₙ (which is a data block of N data samples) for computation of the partial sum Pᵢ is smaller than the number of all data samples included in the data sequence rₙ (which is a data block of N data samples), the computation of the partial sum Pᵢ has reduced complexity. In a typical PRN code, one half of the code bits are 1's, and the other half of the code bits are 0's. That is, the number of zero code bits 0 in the code sequence C_{i,n} is equal to the number of non-zero code bits 1 in the same code sequence C_{i,n}, and half of computation can be reduced therefore. It should be noted that only addition operations are required by computation of the partial sum Pᵢ.

In accordance with the above formula (3), the processing circuit 104 obtains a multiplication result (i.e., 2·Pᵢ) from multiplying the partial sum Pᵢ by a predetermined factor (i.e., 2), and then generates the correlation value Sᵢ between the data sequence rₙ and the code sequence C_{i,n} by subtracting the multiplication result (i.e., 2·Pᵢ) from the sum S of all data samples (i.e., S=Σₙ₌₀^{N-1}rₙ). The same sum S can be shared among computation of correlation values S₀-S_{M-1} for code sequences C_{0,n}-C_{M-1,n}, and thus the computation complexity of the correlation values S₀-S_{M-1} can be reduced greatly.

As shown in FIG. 2, one bit-shifting circuit 206_i for multiplying the partial sum Pᵢ by the predetermined factor (i.e., 2) is required for computation of each correlation value Sᵢ (i={0, . . . , M−1}). With regard to the correlator design, what is concerned is the relative magnitude between the correlation values S₀-S_{M-1} rather than the absolute magnitude of each of the correlation values S₀-S_{M-1}. The correlation computation apparatus 200 shown in FIG. 2 can be modified to further reduce the computation complexity. For example, the computation of each correlation value Sᵢ can be simplified by using the following formula.

$${S}_{i} = \frac{S - 2 \cdot {P}_{i}}{2} = \frac{S}{2} - {P}_{i} \qquad ( 5 )$$

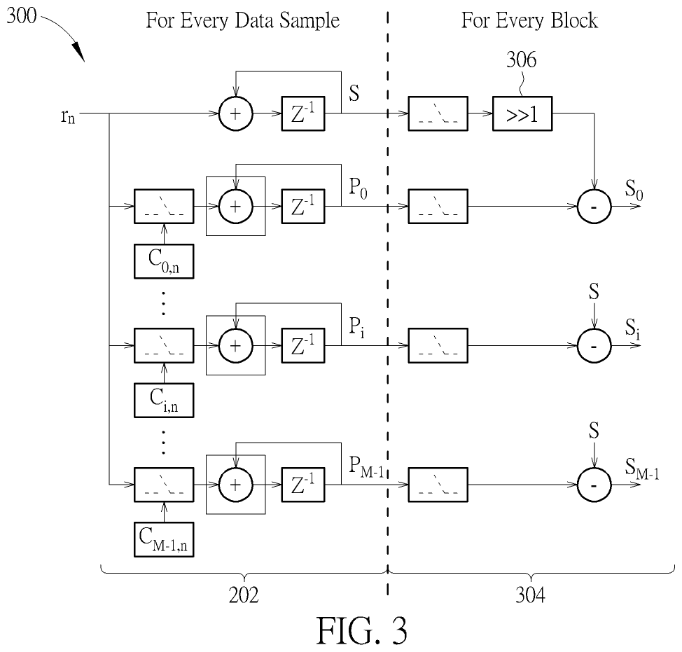

Based on above formulas (1), (4) and (5), the correlation computation apparatus 100 shown in FIG. 1 may be implemented using the correlation computation apparatus 300 shown in FIG. 3, where the accumulation-based circuit 102 may be implemented by the circuit block 202, and the processing circuit 104 may be implemented by the circuit block 304. Compared to the circuit block 204 using M bit-shifting circuits 206_0-206_M−1, the circuit block 304 requires only a single bit-shifting circuit 306. The number of bit-shifting circuits required by computation of correlation values S₀-S_{M-1} is reduced greatly. The bit-shifting circuit 306 is used for obtaining a division result (i.e., S/2) from dividing the sum of all data samples (i.e., S=Σₙ₌₀^{N-1}rₙ) by a predetermined factor (i.e., 2). In accordance with the above formula (5), the processing circuit 104 (which is implemented by the circuit block 304) generates the correlation value Sᵢ between the data sequence rₙ and the code sequence by subtracting the partial sum Pᵢ from the division result (i.e., S/2).

Regarding the exemplary designs shown in FIG. 2 and FIG. 3, partial sums P₀-P_{M-1} for different code sequences C_{0,n}-C_{M-1,n} are computed independently. It is possible that the code sequences have the same bit pattern at consecutive bit positions. Hence, a partial sum derived from accumulating data sample(s) selected from a data word (partial data sequence) that is paired with the same bit pattern (partial code sequence) in multiple code sequences can be shared by computation of partial sums for multiple code sequences, thereby further reducing the computation complexity.

In some embodiments of the present invention, the accumulation-based circuit 102 is arranged to categorize all data samples included in the data sequence rₙ into J (J>1) data words, each having D (D>1) consecutive data samples, where N=J·D; and is further arranged to categorize all code bits included in each code sequence C_{i,n} into J (J>1) code words E_{i,j} (j={0, . . . , J−1}), each having D (D>1) consecutive code bits. Note that we can also choose D and J so that N=J·D−k. That is, we can add k dummy bits to the data samples. For example, k one's are added to the tail of the received and local code sequence, respectively. With regard to computation of the correlation value Sᵢ for the code sequence C_{i,n}, the accumulation-based circuit 102 is arranged to accumulate J selected combinational sums one by one to generate the partial sum Pᵢ. For a specific data word (which consists of D consecutive data samples) being one of the data words in the data sequence rₙ, the accumulation-based circuit 102 generates (2^{D}−1) combinational sums W_{j,e} that are pre-computed sums obtained according to D data samples included in the specific data word, where e={1, . . . , 2^{D}−1}. After the (2^{D}−1) combinational sums W_{j,e} are available, the accumulation-based circuit 102 refers to a specific code word E_{i,j} (which is one of the code words in the code sequence C_{i,n} and paired with the specific data word) to select one of the (2^{D}−1) combinational sums W_{j,e} as one of the J selected combinational sums that are involved in computation of the partial sum Pᵢ for the code sequence C_{i,n}.

Suppose that 3 (D=3) data samples in the data sequence rₙ is grouped as one data word. For each data word, the accumulation-based circuit 102 computes 7 combinational sums W_{j,e}, each being a partial sum of the data word that is computed in a way similar to that specified in the formula (4), where e={1, 2, . . . , 7} and there are J data words per data sequence rₙ (which is a data block of N data samples). Suppose that 3 data samples grouped into the same data word are labeled by {Rₙ, Rₙ₋₁, Rₙ₋₂}. The combinational sum W_{j,1} is obtained from data sample Rₙ₋₂ that is selected from the data samples {Rₙ, Rₙ₋₁, Rₙ₋₂} according to code bits included in a code word “001” which is labeled by a decimal value e=1. The combinational sum W_{j,2} is obtained from a selected data sample Rₙ₋₁ that is selected from the data samples {Rₙ, Rₙ₋₁, Rₙ₋₂} according to code bits included in a code word “010” which is labeled by a decimal value e=2. The combinational sum W_{j,3} is computed as W_{j,3}=Rₙ₋₁+Rₙ₋₂ where data samples Rₙ₋₁ and Rₙ₋₂ are selected from the data samples {Rₙ, Rₙ₋₁, Rₙ₋₂} according to code bits included in a code word “011” with a decimal value label e=3. The combinational sum W_{j,4} (W_{j,4}=Rₙ) is obtained from one data sample Rₙ selected from the data samples {Rₙ, Rₙ₋₁, Rₙ₋₂} according to code bits included in a code word “100” with a decimal value label e=4. The combinational sum W_{j,5} (W_{j,5}=Rₙ+Rₙ₋₂) is obtained from Rₙ and Rₙ₋₂ that are selected from the data samples {Rₙ, Rₙ₋₁, Rₙ₋₂} according to code bits included in a code word “101” with a decimal label value e=5. The combinational sum W_{j,6} (W_{j,6}=Rₙ+Rₙ₋₁) is obtained from Rₙ and Rₙ₋₁ that are selected from the data samples {Rₙ, Rₙ₋₁, Rₙ₋₂} according to code bits included in a code word “110” with a decimal label value e=6. The combinational sum W_{j,7} (W_{j,7}=Rₙ+Rₙ₋₁+Rₙ₋₂) is obtained from all data samples Rₙ, Rₙ₋₁, and Rₙ₋₂ that are selected from the data samples {Rₙ, Rₙ₋₁, Rₙ₋₂} according to code bits included in a code word “111” with a decimal label value e=7. It should be noted that, since partial sum accumulation is skipped for the code word “000”, no combinational sum is pre-computed for the code word “000”.

In one exemplary implementation, the sum S of all data samples included in the data sequence rₙ can be computed using the above formula (1). Alternatively, since the combinational sum W_{j,7} (W_{j,7}=Rₙ+Rₙ₋₁+Rₙ₋₂) is pre-computed for each of the J data words, the sum S of all data samples included in the data sequence rₙ can be obtained from accumulating combinational sums W_{j,7} pre-computed for J data words. Specifically, the above formula (1) may be reformulated as below.

S=Σₙ₌₀^{N-1}rₙ=Σⱼ₌₀^{J-1}W_{j,7} (6)

Since there are J data words in the data sequence rₙ {rₙ, n=0, . . . , N−1} and one of the pre-computed combinational sums W_{j,e} (j={0, . . . , J−1}) is selected as a partial sum of each data word according to a corresponding code word E_{i,j} in a code sequence C_{i,n}, the partial sum Pᵢ (i={0, . . . , M−1}) may be computed using the following formula (7).

$${P}_{i} = {\sum }_{j = 0}^{J - 1} {\sum }_{e = 1}^{7} {δ}_{{E}_{i , j} = e} \cdot {W}_{j , e} , where {δ}_{{E}_{i , j} = e} = \{ \begin{matrix}1 , if {E}_{i , j} = e \\ 0 , if {E}_{i , j} \neq e\end{matrix} \qquad ( 7 )$$

In other words, the combinational sum W_{j,1} pre-computed for the current data word is selected and output for accumulation if the code word E_{i,j} corresponding to the current data word is “001”. The combinational sum W_{j,2} pre-computed for the current data word is selected and output for accumulation if the code word E_{i,j} corresponding to the current data word is “010”. The combinational sum W_{j,3} pre-computed for the current data word is selected and output for accumulation if the code word E_{i,j} corresponding to the current data word is “011”. The combinational sum W_{j,4} pre-computed for the current data word is selected and output for accumulation if the code word E_{i,j} corresponding to the current data word is “100”. The combinational sum W_{j,5} pre-computed for the current data word is selected and output for accumulation if the code word E_{i,j} corresponding to the current data word is “101”. The combinational sum W_{j,6} pre-computed for the current data word is selected and output for accumulation if the code word E_{i,j} corresponding to the current data word is “110”. The combinational sum W_{j,7} pre-computed for the current data word is selected and output for accumulation if the code word E_{i,j} corresponding to the current data word is “111”.

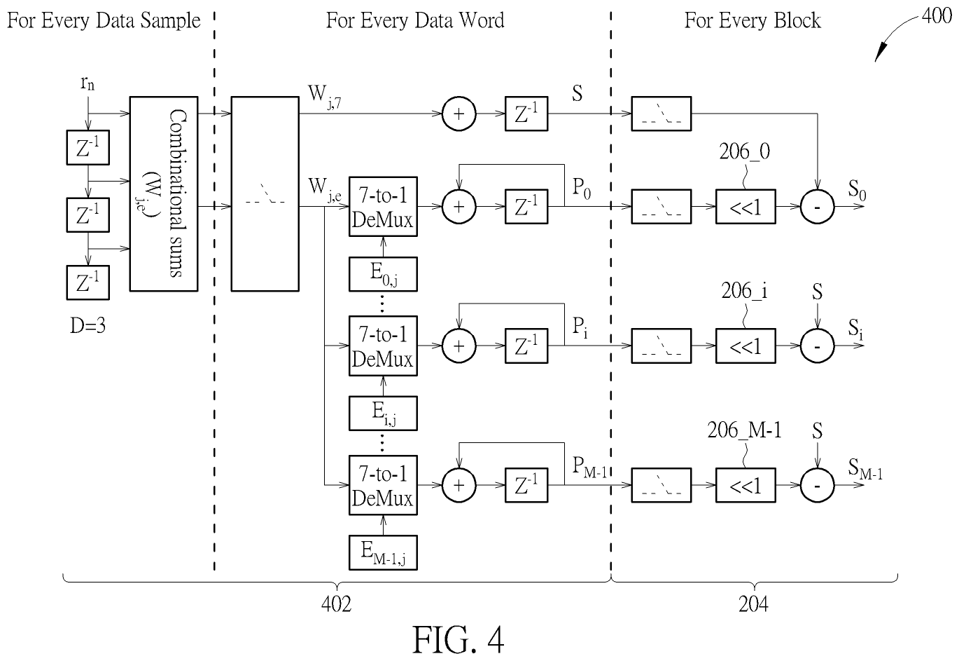

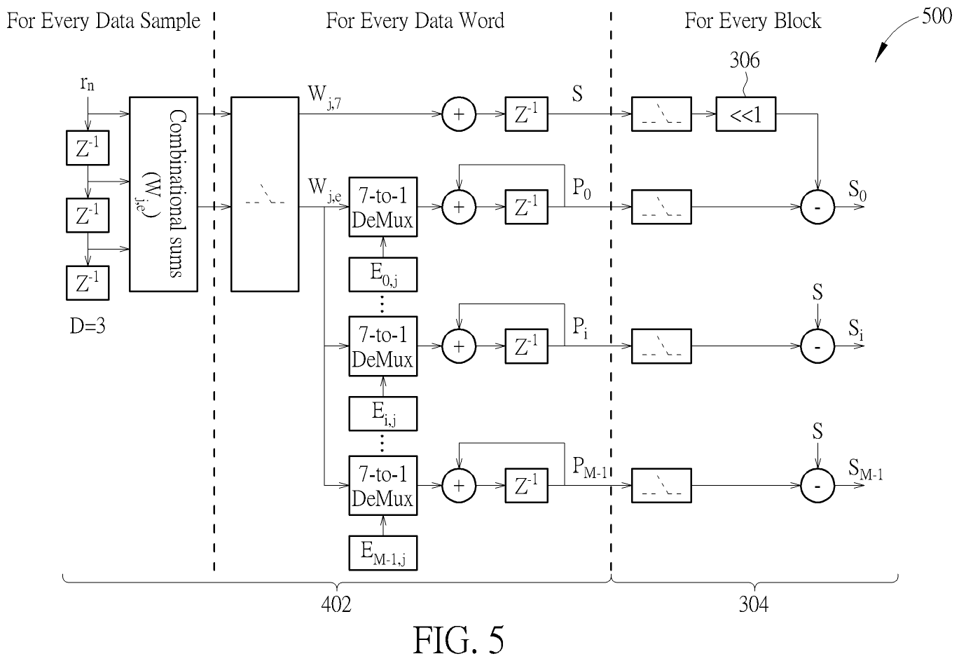

After the partial sum Pᵢ (i={0, . . . , M−1}) is available, the correlation value Sᵢ (i={0, . . . , M−1}) can be computed using the above formula (3) or (5). Based on the formulas (3), (6) and (7), the correlation computation apparatus 100 shown in FIG. 1 may be implemented using the correlation computation apparatus 400 shown in FIG. 4, where the accumulation-based circuit 102 may be implemented by the circuit block 402, and the processing circuit 104 may be implemented by the circuit block 204. Based on the formulas (5), (6) and (7), the correlation computation apparatus 100 shown in FIG. 1 may be implemented using the correlation computation apparatus 500 shown in FIG. 5, where the accumulation-based circuit 102 may be implemented by the circuit block 402, and the processing circuit 104 may be implemented by the circuit block 304.

For each data block, computation of combinational sums and selection of one of the combinational sums in the circuit block 402 may be summarized by the following table.

TABLE 1

| E | e | | 7-to-1 DeMux Output |
|---|---|---|---|
| (binary) | (decimal) | Value of Wₑ | controlled by E |
| 000 | 0 | Not Available | Don't integrate |
| 001 | 1 | Rₙ₋₂ | W₁ |
| 010 | 2 | Rₙ₋₁ | W₂ |
| 011 | 3 | Rₙ₋₁ + Rₙ₋₂ | W₃ |
| 100 | 4 | Rₙ | W₄ |
| 101 | 5 | Rₙ + Rₙ₋₂ | W₅ |
| 110 | 6 | Rₙ + Rₙ₋₁ | W₆ |
| 111 | 7 | Rₙ + Rₙ₋₁ + Rₙ₋₂ | W₇ |

One combinational sum is computed once and may be shared among the computation of multiple partial sums for different code sequences. For example, if the code word E_{i,j} in the code sequence C_{i,n} and the code word E_{M-1,j} in the code sequence C_{M-1,n} have the same code bits “110”, the pre-computed combinational sum W_{j,6} is selected and involved in the computation of the partial sum P₁, and is also selected and involved in the computation of the partial sum P_{M-1}. In this way, the computation complexity of the partial sums P₀-P_{M-1} can be further reduced by reusing the pre-computed combinational sums.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A correlation computation method comprising:
obtaining a first sum of all data samples included in a data sequence;
obtaining a second sum of selected data samples that are selected from the data sequence according to code bits included in a first code sequence; and
deriving, by a processing circuit, a first correlation value between the data sequence and the first code sequence from the first sum and the second sum.

2. The correlation computation method of claim 1, wherein a number of the selected data samples selected from the data sequence is smaller than a number of all data samples included in the data sequence.

3. The correlation computation method of claim 1, wherein obtaining the second sum of the selected data samples comprises:
accumulating the selected data samples one by one to generate the second sum, comprising:
checking if a specific code bit included in the first code sequence has a predetermined code value; and
in response to the specific code bit having the predetermined code value, selecting a specific data sample that is included in the data sequence and corresponds to the specific code bit as one of the selected data samples.

4. The correlation computation method of claim 1, wherein all data samples included in the data sequence are categorized into a plurality of data words, each having a plurality of data samples; all code bits included in the first code sequence are categorized into a plurality of first code words, each having a plurality of code bits; and obtaining the second sum of the selected data samples comprises:
accumulating a plurality of first selected combinational sums one by one to generate the second sum, comprising:
for a specific data word included in the plurality of data words, generating a plurality of combinational sums according to specific data samples included in the specific data word; and
referring to a specific first code word that is included in the first code sequence and corresponds to the specific data word, for selecting one of the plurality of the combinational sums as one of the plurality of first selected combinational sums.

5. The correlation computation method of claim 4, further comprising:
obtaining a third sum of selected data samples that are selected from the data sequence according to code bits included in a second code sequence, wherein the second code sequence is distinct from the first code sequence, and the third sum is involved in computation of a second correlation value between the data sequence and the second code sequence;
wherein all code bits included in the second code sequence are categorized into a plurality of second code words, each having a plurality of code bits; and obtaining the third sum of selected data samples comprises:
accumulating a plurality of second selected combinational sums to generate the third sum, comprising:
referring to a specific second code word that is included in the second code sequence and corresponds to the specific data word, for selecting said one of the plurality of the combinational sums as one of the plurality of second selected combinational sums, wherein the specific second code word included in the second code sequence is identical to the specific first code word included in the first code sequence.

6. The correlation computation method of claim 1, further comprising:
obtaining a third sum of selected data samples that are selected from the data sequence according to code bits included in a second code sequence, wherein the second code sequence is distinct from the first code sequence; and
deriving a second correlation value between the data sequence and the second code sequence from the first sum and the third sum.

7. The correlation computation method of claim 1, wherein obtaining the first sum of all data samples included in the data sequence comprises:
accumulating all data samples included in the data sequence one by one to generate the first sum.

8. The correlation computation method of claim 1, wherein all data samples included in the data sequence are categorized into a plurality of data words, each having a plurality of data samples; and obtaining the first sum of all data samples included in the data sequence comprises:
accumulating a plurality of selected combinational sums to generate the first sum, comprising:
for a specific data word included in the plurality of data words, generating a plurality of combinational sums according to specific data samples included in the specific data word; and
selecting one of the plurality of combinational sums that is equal to a sum of the specific data samples as one of the plurality of selected combinational sums.

9. The correlation computation method of claim 1, wherein deriving the first correlation value between the data sequence and the first code sequence from the first sum and the second sum comprises:
obtaining a multiplication result from multiplying the second sum by a predetermined factor; and
generating the first correlation value by subtracting the multiplication result from the first sum.

10. The correlation computation method of claim 1, wherein deriving the first correlation value between the data sequence and the first code sequence from the first sum and the second sum comprises:
obtaining a division result from dividing the first sum by a predetermined factor; and
generating the first correlation value by subtracting the second sum from the division result.

11. A correlation computation apparatus comprising:
an accumulation-based circuit, arranged to obtain a first sum of all data samples included in a data sequence, and obtain a second sum of selected data samples that are selected from the data sequence according to code bits included in a first code sequence; and
a processing circuit, arranged to derive a first correlation value between the data sequence and the first code sequence from the first sum and the second sum.

12. The correlation computation apparatus of claim 11, wherein a number of the selected data samples selected from the data sequence is smaller than a number of all data samples included in the data sequence.

13. The correlation computation apparatus of claim 11, wherein the accumulation-based circuit is arranged to accumulate the selected data samples one by one to generate the second sum, comprising:
checking if a specific code bit included in the first code sequence has a predetermined code value; and
in response to the specific code bit having the predetermined code value, selecting a specific data sample that is included in the data sequence and corresponds to the specific code bit as one of the selected data samples.

14. The correlation computation apparatus of claim 11, wherein all data samples included in the data sequence are categorized into a plurality of data words, each having a plurality of data samples; all code bits included in the first code sequence are categorized into a plurality of first code words, each having a plurality of code bits; and the accumulation-based circuit is arranged to accumulate a plurality of first selected combinational sums one by one to generate the second sum, comprising:
for a specific data word included in the plurality of data words, generating a plurality of combinational sums according to specific data samples included in the specific data word; and
referring to a specific first code word that is included in the first code sequence and corresponds to the specific data word, for selecting one of the plurality of the combinational sums as one of the plurality of first selected combinational sums.

15. The correlation computation apparatus of claim 14, wherein the accumulation-based circuit is further arranged to obtain a third sum of selected data samples that are selected from the data sequence according to code bits included in a second code sequence, wherein the second code sequence is distinct from the first code sequence, and the third sum is involved in computation of a second correlation value between the data sequence and the second code sequence; all code bits included in the second code sequence are categorized into a plurality of second code words, each having a plurality of code bits; and the accumulation-based circuit is arranged to accumulate a plurality of second selected combinational sums to generate the third sum, comprising:
referring to a specific second code word that is included in the second code sequence and corresponds to the specific data word, for selecting said one of the plurality of the combinational sums as one of the plurality of second selected combinational sums, wherein the specific second code word included in the second code sequence is identical to the specific first code word included in the first code sequence.

16. The correlation computation apparatus of claim 11, wherein the accumulation-based circuit is further arranged to obtain third sum of selected data samples that are selected from the data sequence according to code bits included in a second code sequence, wherein the second code sequence is distinct from the first code sequence; and the processing circuit is further arranged to derive a second correlation value between the data sequence and the second code sequence from the first sum and the third sum.

17. The correlation computation apparatus of claim 11, wherein the accumulation-based circuit is arranged to accumulate all data samples included in the data sequence one by one to generate the first sum.

18. The correlation computation apparatus of claim 11, wherein all data samples included in the data sequence are categorized into a plurality of data words, each having a plurality of data samples; and the accumulation-based circuit is arranged to accumulate a plurality of selected combinational sums to generate the first sum, comprising:
for a specific data word included in the plurality of data words, generating a plurality of combinational sums according to specific data samples included in the specific data word; and
selecting one of the plurality of combinational sums that is equal to a sum of the specific data samples as one of the plurality of selected combinational sums.

19. The correlation computation apparatus of claim 11, wherein the processing circuit is arranged to obtain a multiplication result from multiplying the second sum by a predetermined factor, and generate the first correlation value by subtracting the multiplication result from the first sum.

20. The correlation computation apparatus of claim 11, wherein the processing circuit is arranged to obtain a division result from dividing the first sum by a predetermined factor, and generate the first correlation value by subtracting the second sum from the division result.
